(19) United States
(12) Patent Application Publication
(10) Pub. No.: US 2024/0052691 A1
(43) Pub. Date: Feb. 15, 2024

(54) ROLL DOOR UNIT, ROLL-UP DOOR AND USE OF A ROLL DOOR UNIT FOR COVERING A DOOR OPENING

(71) Applicant: Assa Abloy Entrance Systems AB, Landskrona (SE)

(72) Inventor: Helmut WUESTNER, Lippstadt (DE)

(21) Appl. No.: 18/268,288

(22) PCT Filed: Dec. 16, 2021
(86) PCT No.: PCT/EP2021/086105

§ 371 Date: Jun. 19, 2023

(30) Foreign Application Priority Data
Dec. 22, 2020 (SE) 2030370-7

(51) Int. Cl. E06B 9/17; E06B 9/58

(52) U.S. Cl. CPC E06B 9/17; E06B 9/58

(57) ABSTRACT

The invention relates to a roll door unit (1 1) for covering a door opening, a roll-up door (IO) comprising this roll door unit and a specific use of the roll door unit (IO). The roll door unit (11) comprises a flexible door panel (16), a rotatable roll shaft (15) for rolling-up the flexible door panel (16), side frames (12), mounting flanges (14) for mounting the roll shaft (15) to the side frames (12), a connecting element (17) for connecting a motor unit (18) to the roll shaft (15), and supporting beams (13) for supporting the side frames (12) in mounted state and being connected or connectable to a wall or ground, whereby a longitudinal axis of the roll shaft (15) is positioned in alignment with a plane being spanned by the supporting beams (13). The technical solution described is characterized in that, the support beams (13) and the mounting flanges (14) are arranged at a distance from one another in such a way, that in mounted state forces exerted by the roll shaft (15) are introduced into the supporting beams (13) indirectly through the side frames (12).

The invention relates to a roll door unit for covering a door opening, a roll-up door comprising this roll door unit and a specific use of the roll door unit. The roll door unit comprises a flexible door panel, a rotatable roll shaft for rolling up the flexible door panel, side frames, mounting flanges for mounting the roll shaft of the side frames, a connecting element for connecting a motor unit to the roll shaft, and supporting beams for supporting the side frames in mounted state and being connected or connectable to a wall or ground, whereby a longitudinal axis of the roll shaft is positioned in alignment with the plane being spanned by the supporting beams.

Roll-up doors are well-known elements of manufacturing or production facilities and ensure a fast and secure separation as well of production halls, production lines as of working areas of machines or robots. In the technical area of automated manufacturing the demands are high as the smallest interruption or delay can break down the flow of production or endanger employees. Here, especially machine protection doors help manufacturers to avoid both scenarios. These doors are integrated into the manufacturing and/or logistic processes and open and close according to the production run. They enable the rapid change from complete isolation a production step to free access to workpieces and machines within seconds. Therefore, short cycle times can be realized and due to the installation of roll-up doors close to working areas of machines or robots the space available for manufacturing can be used very efficient. Thus, roll-up doors help to protect people in highly automated areas, making processes safer.

In this context EP 2 304 154 A1 describes a roll-up door with a flexible door panel comprising a plurality of ridged lamellae or panel segments and a flexible strip as a lifting device for selectively raising and lowering the door panel. The roll-up door with a flexible door panel includes side frames on the left and right side of an opening. The plurality of lamellae or panel segments are adapted to travel within guide rails arranged in the side frames. Furthermore, a lifting component is described, which is attached to the door and to a roll shaft mounted above the doorway. To operate the door, the roll shaft is activated in one direction to roll the door panel up onto the shaft to open the doorway. Rotation in the opposite direction unrolls the door panel to close the doorway.

Moreover, roll-up doors with a curtain made of soft plastic, like PVC, are known. Such roll-up door is described in WO 2015/121255 A1. In practice, the rolling doors are exposed to considerable forces because of differences in air pressure on either side of the rolling door. Since rolling doors are predominantly used in an industrial environment, they are often prone to damage as a result of collisions, such as by vehicles, in particular forklift trucks. Therefore, the roll-up door described in EP 2015/121255 A1 comprises a door curtain having lateral edges which are coupled to guiding rails for guiding the curtain during rolling and unrolling thereof around a roll shaft, whereupon said lateral edges are resilient to afford a reversible deformation of the curtain upon exposure to a pressure applied transverse to the plane defined by the curtain, such as wind or an impact with a vehicle or similar.

Another roll-up door with a door curtain as flexible door panel is known from EP 3 306 026 B1. The roll-up door comprises a flexible door panel, a roll shaft, side frames, mounting flanges for mounting the roll shaft above the side frames, a motor and a housing at the top for covering the roll shaft and the raised door curtain. The mounting flanges are connected at their bottom side to upper ends of supporting beams which serve as a support for the side frames. Here, the roll shaft is positioned on the rear side of the flexible door panel, and thus on the same side as the working area which should be separated from the surroundings.

Regarding the side frame of a roll-up door, usually the side frames are mounted on the outside in relation to the work area located on the rear side of the roll-up door, so that they are accessible from the outside for service and adjustment work, especially to service or repair switches, sensors or sensors located in the side frames.

Since roll-up doors known from the prior art are used to cover a large number of different openings, a wide variety of different door components like side frames and supporting beams for different door heights have to be provided. In addition, roll-up doors and their components have to be safely accommodated in minimum space.

Taking roll-up doors known from the prior art and the above mentioned problems into account an object of the invention is to provide roll-up doors for separating work areas located on the rear side of their flexible panel comprising side frames with service and maintenance points on the front side. Furthermore, it should be possible to arrange the roll shaft on the rear side of the flexible panel and to minimize torque acting on the connections between the mounting flanges and the side frames of the door. A roll door according to the invention should require considerably less space in front of the flexible panel. In addition, it should be possible to provide roll doors for openings of different size using as many common parts with identical dimensions as feasible. Above all, it is desirable to have a common support structure especially identical supporting beams independent of the height of the opening, which should be covered. Moreover, a roll-up door having a cost-effective and comparatively simple design and being easy to construct should be realized.

The instant invention is directed to the problem of how to overcome some or all of the problems known from the prior art. The objectives mentioned above are met with a roll door unit according to claim 1 as well as with a roll-up door according to claim 13. Furthermore claim 15 contains a specific use of a roll door unit according to the invention.

Preferred embodiments of the invention are disclosed in the dependent claims and will be explained in detail in the following description. Additionally, certain specific embodiments of the invention are explained with the help of drawings.

The invention is based on a roll door unit for covering a door opening comprising a flexible door panel, a rotatable roll shaft for rolling-up the flexible door panel, side frames, mounting flanges for mounting the roll shaft to the side frames, a connecting element for connecting a motor unit to the roll shaft, and supporting beams for supporting the side frames in mounted state and being connected or connectable to a wall or ground, whereby a longitudinal axis of the roll shaft is positioned in alignment with a plane being spanned by the supporting beams. According to the invention the supporting beams and the mounting flanges are arranged at a distance from one another in such a way, that in mounted state forces exerted by the roll shaft are introduced into the supporting beams indirectly through the side frames. Here, since the mounting flanges are not in direct contact with the supporting beams forces exerted by the roll shaft will at first introduced into the mounting flanges and then into the supporting beams. Preferably, the upper ends of the mounting flanges are arranged below or on the same level with the upper end of the side frames. Furthermore, beneficially the mounting flanges are connected to the side frames.

Since the mounting flanges are spaced away from the top ends of the supporting beams it is not necessary to have supporting beams of varying lengths to support side frames of different lengths for providing roll-up doors covering openings with different heights. According to the invention only a few different supporting beams are required to be able to provide roll door units for covering openings of different heights. It is conceivable, to have supporting beams of uniform length or at least only a few different supporting beams of stepwise changing lengths.

In a preferred embodiment of the invention the connection of the mounting flanges and the roll shaft is arranged at least partially above the supporting beams. Furthermore, the mounting flanges are fixed to the side frames advantageously with at least one screw or rivet.

Preferably, the side frames comprise a U-shaped profile. Furthermore, it is an advantage, if the mounting flanges are at least partly connected to the side frames in an area arranged between the legs of the U-shaped profile. According to this technical solution it is conceivable that the mounting flanges are connected to at least one leg of the U-profile.

In a preferred embodiment of the invention, in a mounted state the roll shaft is positioned on the rear side of the flexible door panel, whereby the work area which should be protected by the lowered flexible door panel is also located on the rear. Since the roll shaft is arranged on the rear side of the flexible door panel preferably realized as door curtain the visible surface is directed to the front side, where workers and vehicles stay. In addition, an arrangement with the roll shaft on the rear side of the flexible panel provides more space on the front side, and thus the risk of accidents for workers and vehicles because of door components protruding into the area in front of the flexible door panel is reduced.

According to another embodiment of the invention the supporting beams are at least partly arranged between legs of a profile, especially a U-profile, of the side frames. Preferably, the supporting beams are connected to an area of the side frames arranged between the legs of a U-profile.

In a preferred embodiment at least one sensor and/or a signal unit is connected to at least one of the side frames. Such a sensor may comprise a motion and/or photo sensor and is connectable by wire or wireless to a control system. With the help of at least one of the aforementioned sensors connected to a control system it is possible to control a movement of a roll-up door with a roll door unit according to the invention in such a way, that a movement of the flexible door panel is stopped or avoided when a person or vehicle is in the vicinity of the door opening. Furthermore, it is conceivable that the control system generates data transmittable to at least one drive unit or control member to initiate a door movement depending on specific steps of a manufacturing, production, or logistic process. Here, it is conceivable that the roll door unit according to the invention comprises at least one interface for connecting the door unit to the control system as to move the flexible door panel with different speeds, driving power and/or travelling distance. Due to the use of a roll door unit having at least one interface for connecting it is possible to integrate such roll door unit into an automated manufacturing or logistic process, thus opening and closing according to the production run, and enabling a rapid change from complete isolation of the production step to free access to workpiece and machine within a comparatively short time.

According to a further embodiment of the invention the flexible door unit comprises a plurality of door panel elements, e.g. aluminium elements, or a flexible door curtain. If a door curtain is used as flexible door panel, preferably it is made of soft plastic, like polyvinyl chloride (PVC). Furthermore, it is conceivable to optimize thermal insulation and to increase the wind stability of a flexible door panel by increasing its thickness, using elements made of isolating material and/or to integrate reinforcing or protection elements. In a preferred embodiment the flexible door panel comprises at least one transparent area allowing to look through the lowered door.

Incidentally, the invention is also related to a role-up door comprising a roll door unit according to at least one embodiment described above. Advantageously, such a role-up door is located in a production facility and/or a warehouse and at least temporarily separates one area from another area. Again, the roll door according to the invention separates a work area and/or protects a machine or a worker.

In addition, the invention is also related to a specific use of a role door unit according to at least one of the above described embodiments. Thus, this roll door unit is used for temporarily separating a storage and/or work area and/or for protecting a machine or robot or a worker.

Further features properties and advantages of the present invention will become clear from the following description of embodiments in conjunction with the accompanying drawings. The embodiments do not limit the scope of the present invention which is determined by the independent claims.

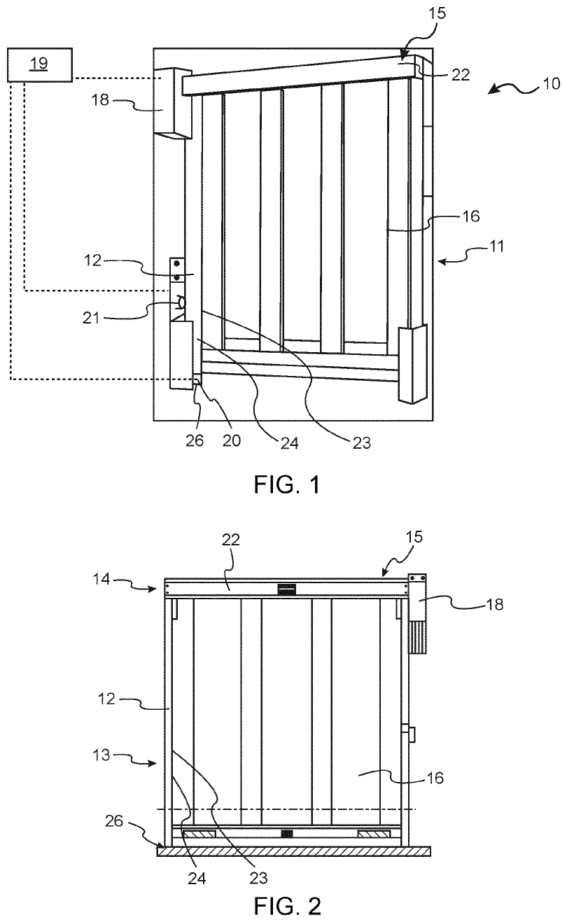

FIG. 1: Perspective view of a roll-up door with a roll door unit according to the invention being integrated into an automated manufacturing process;

FIG. 2: Front view of a roll door unit according to the invention;

FIG. 3: Perspective view of supporting beams, side frames, mounting flanges and connecting elements for fastening a roll shaft of a roll door unit according to the invention, and

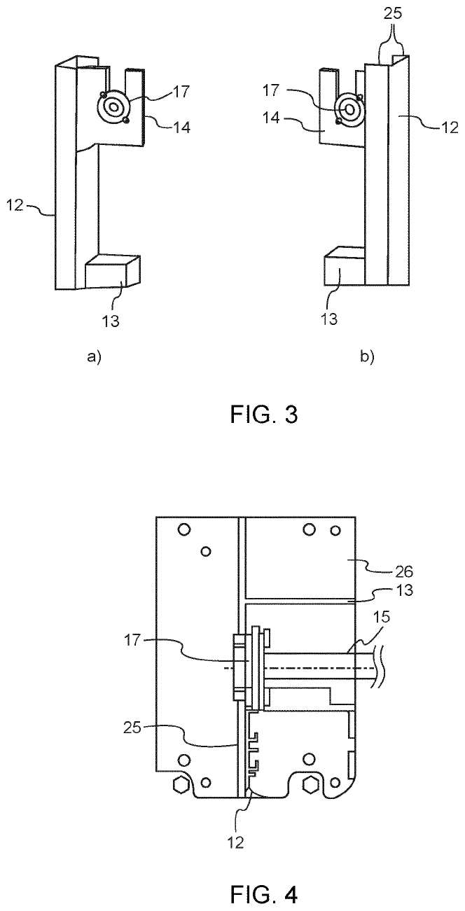

FIG. 4: Top view of a supporting beam, side frame, mounting flange and connecting element for fastening a roll shaft according to the invention of a roll door unit according to the invention.

FIG. 1 shows a perspective view of a roll-up door 10 with a roll door unit 11 according to the invention being integrated into an automated manufacturing process. The roll door unit 11 comprises a door curtain as flexible door panel 16 which is shown in the lowered state. The roll-up door 10 is integrated into an automated manufacturing process implemented in a production facility and opens and closes according to the production run. Here, the role door 10 is used as a machine protection door to either isolate the machine during a production step realized behind the lowered flexible panel or to give free access to workpieces and the machine.

The role-up door 10 comprises a flexible door panel 16, which is in an open state rolled-up around a roll shaft 15 coupled to a motor unit 18 to turn the roll shaft 15 whenever an opening or closing of the role door 10 is required. According to the embodiment shown in FIG. 1 the role door 10 used as a machine protection door comprises a roll shaft 15, which is positioned on the rear side of the flexible door panel 16. Since the front side of the flexible door panel 16 is directed to an area where workers stay or industrial vehicles move it is important, that there is enough space in front of the role door 10 to avoid accidents in front of the door due to any collisions, e.g. because vehicles collide with components of the roll door 10 extending into the area in front of the role door 10.

Because the roll shaft 15 connected to the flexible door panel 16 is located on the rear side of the flexible door panel 16 more space on the front side of the roll-up door 10 is provided for workers and vehicles. Therefore, the risk for workers and vehicles because of the physical presence of any door element is reduced.

The roll door unit 11 of the roll-up door 10 shown in FIG. 1 comprises two side frames 12 and a housing 22 at the top for covering as well the roll shaft 15 as the rolled-up door curtain surrounding an opening in lowered state. The flexible door panel 16 connected to and moved by the roll shaft 15 comprises guiding elements 23 at its side edges arranged in guiding rails 24 of the side frames 12. When the flexible door panel 16 is raised or lowered the guiding elements 23 slide up or down in the guiding rails 24 of the side frames 12. Furthermore, these guiding elements 23 keep the flexible door panel 16 in its position when objects or persons push against the roll-up door 10.

In addition, at the top of the roll-up door 10 a motor unit 18 is located at the side of the roll shaft 15 to open and close the roll-up door 10. Here, the motor unit 18 is connected to a central control system 19 of the automated manufacturing process to raise or lower the roll-up door depending on the production run. Next to the roll-up door 10 at the side switches 21 as well as operating and sensor elements 20 are located. Side switches 21 are preferably placed about 100 mm above the floor. With the help of the switches 21 and operating elements the door can be opened and closed manually whereas the at least one motion sensor transmits data to the motor and/or the central control system 19 in such a way that closing of the door 10 can be stopped or the door 10 can be opened automatically whenever a person or a vehicle approaches the roll-up door 10.

Often the space on the front side of a flexible door panel 16 is limited. Depending on the height of a role-up door workers or vehicles moving closely past the door risk colliding with the protruding roll shaft housing 22. According to the embodiment shown in FIG. 1 the roll shaft 15 is arranged behind the side frames 12 and mounted to the side frames on their rear side, so that the housing 22 surrounding the roll shaft 15 extends only a little bit into the space in front of the roll-up door 10. Nevertheless, the fronts of the side frames 12 are still arranged on the front side of the roll door 10 as to service and maintenance points are easily accessible.

Additionally, FIG. 2 shows the front view of a roll door unit 11 according to the invention. Again, the roll shaft 15 for rolling-up and unrolling the flexible door panel 16 realized as a door curtain is covered by a housing 22 and arranged on the rear side of the roll-up door 10, which is the work area of a machine or robot. Furthermore, the door unit 11 comprises two side frames 12 with guiding rails 24 for guiding elements 23. The guiding elements 23 slide within the guiding rails 24 up or down, when the door curtain is raised or lowered.

The roll shaft 15 is driven by a motor unit 18 which is located on one side at the top of the roll-up door 10. A tubular motor can be used as well. During the use of the roll-up door 10 shown in FIG. 2 it is possible to either isolate the working area of a machine or robot from the rest of a production line or to allow free access to the working area, especially to workpieces.

FIG. 3 shows a perspective view of supporting beams 13, side frames 12, mounting flanges 14 and connecting elements 17 for fastening a roll shaft 15 of a roll door unit 11 according to the invention. These elements are part of the roll-up door 10 shown in FIG. 2.

In FIG. 3 a supporting beam 13, side frame 12 and mounting flange 14 with a connecting element 17 for fastening a roll shaft 15 are shown which are arranged on the left side of the roll-up door according to FIG. 2. Here, FIG. 3 a) shows the side frame 12, supporting beam 13 and the mounting flange 14 with the connecting element 17 from the inside, while FIG. 3 b) shows side frame 12, supporting beam 13 and the mounting flange 14 with the connecting element 17 from the outside. The mounting flange 14 is attached to the side frame 12 in such a way, that in mounted state of a roll-up door 10 the roll shaft 15 is positioned on the rear side of the flexible door panel 16. Furthermore, the side frame 12 has a U-profile and the mounting flange 14 is as well clipped in an area between the legs of the U-profile as attached to the side frame 12 at least partly in the area of the legs 25 of the U-profile.

According to the invention, the mounting flange 14 is arranged vertically above the supporting beam 13 and attached, e.g. by rivets, to the side frames 12, whereas the supporting beam 13 and the mounting flange 14 are arranged at a distance from one another. Therefore, in mounted state forces exerted by the roll shaft 15 are introduced into the supporting beam 13 indirectly through the side frame 12. Thus, the mounting flange 14 is arranged vertically above the supporting beam but not directly connected to the supporting beam 13. Instead, the mounting flange 14 is attached to the side frame 12 and according to the embodiment shown in FIG. 3 the upper end of the side frame 12 is located above the roll shaft 15 and the mounting flange 14. In addition, the supporting beam 13 providing a support for the side frame 12 and being connected to the side frame 12 is shorter than the side frame 12. Because of this technical solution supporting beams 13 of one length can be combined with different side frames 12 of greater lengths, and therefore implemented into roll door units 11 for openings of different heights.

According to this solution only a few different support beam lengths are required for providing a comparatively big range of roll-up doors 10 with various heights. Thus, only a few pre-produced support beams 13 of different stepwise changing lengths are required for a set of roll-up doors 10 covering openings with different heights. Since the mounting flange 14 is arranged at a distance to the top of the supporting beam, there is no need to produce support beams with different lengths.

Another advantage of the technical solution according to the invention is, that a roll shaft 15, which is located on the rear side of the flexible door panel 16 and being connected to the mounting flange 14 as well above as at a distance to the supporting beams 13 causes comparatively low forces and torque.

FIG. 4 shows a top view of a supporting beam 13, side frame 12, mounting flange 14 and connecting element 17 for fastening a roll shaft 15 used as construction elements for a roll door unit 11 according to the invention. Furthermore, the supporting structure shown in FIG. 4 comprises a bottom plate 26, attached to the support beam 13 for mounting the supporting beam 13 respectively the whole supporting structure to the ground. Again, the mounting flange 14 with the connecting element 17 for fastening a roll shaft 15 is attached to the side frame 12 by rivets. According to the invention, there is no direct contact between the mounting flange 14 and the top of the supporting beam 13 because the supporting beam 13 and the mounting flange 14 are arranged at a distance to one another. Since the mounting flange 14 is attached to the side frame 12 and the side frame 12 is supported by the supporting beam 13 forces that in mounted state are exerted by the roll shaft 15 due to its weight and movement are introduced indirectly into the supporting beam 13 through the side frame 12. The supporting beam 13 is connected to the bottom plate 26 designed to be mounted together with the supporting structure of the roll-up door to the ground, especially a floor of a production facility.

### LIST OF REFERENCE NUMBERS

10 roll-up door
11 roll door unit
12 side frame
13 supporting beam
14 mounting flange
15 roll shaft
16 flexible door panel
17 connecting element
18 motor unit
19 control system
20 sensor element
21 switch
22 housing
23 guiding element
24 guiding rail
25 legs of a profile
26 bottom plate

1. Roll door unit (11) for covering a door opening comprising a flexible door panel (16), a rotatable roll shaft (15) for rolling-up the flexible door panel (16), side frames, (12) mounting flanges (14) for mounting the roll shaft (15) to the side frames (12), a connecting element (17) for connecting a motor unit (18) to the roll shaft (15), and supporting beams (13) for supporting the side frames (12) in mounted state and being connected or connectable to a wall or ground, whereby a longitudinal axis of the roll shaft (15) is positioned in alignment with a plane being spanned by the supporting beams (13), characterized in that, the support beams (13) and the mounting flanges (14) are arranged at a distance from one another in such a way, that in mounted state forces exerted by the roll shaft (15) are introduced into the supporting beams (13) indirectly through the side frames (12).

2. Roll door unit according to claim 1, characterized in that the upper end of the mounting flanges (14) are arranged below or on the same level with the upper ends of the side frames (12).

3. Roll door unit according to claim 1, characterized in that the mounting flanges (14) are connected to the side frames (12).

4. Roll door unit according to claim 1, characterized in that the mounting flanges (14) are arranged at least partly above the supporting beams (13).

5. Roll door unit according to claim 1, characterized in that a joining element for connecting the mounting flanges (14) with the roll shaft (15) is arranged at least partly above the supporting beams (13).

6. Roll door unit according to claim 1, characterized in that the side frames (12) comprise a U-shaped profile.

7. Roll door unit according to claim 6, characterized in that the mounting flanges (14) are at least partly connected to legs (25) of the U-profile of the side frames (12).

8. Roll door unit according to claim 1, characterized in that in the mounted state the roll shaft (15) is positioned on a rear side of the flexible door panel (16), whereby the rear side is located on the same side as a work area of a machine and/or a robot.

9. Roll door unit according to claim 1, characterized in that the supporting beams (13) are at least partly arranged between legs (25) of a profile of the side frames (12).

10. Roll door unit according to claim 1, characterized in that at least one sensor element (20), switch (21) and/or signal unit is connected to the side frames (12).

11. Roll door unit according to claim 10, characterized in that the sensor element (20), the switch (21) and/or the signal unit is connected to an interface for transmitting signals to and/or receiving signals from a signal processing unit of a control system (19).

12. Roll door unit according to claim 1, characterized in that the flexible door panel (16) comprises a curtain.

13. Roll-up door (10) comprising a roll door unit (11) according to claim 1.

14. Production facility and/or work area comprising at least one roll-up door (10) according to claim 13.

15. Use of a roll door unit (11) according to claim 1 for temporarily separating a work area and/or for protecting a machine or robot.
